(19) United States
(12) Patent Application Publication
(10) Pub. No.: US 2014/0337909 A1
(43) Pub. Date: Nov. 13, 2014

(54) NETWORK PERSONAL VIDEO RECORDER SYSTEM, METHOD AND ASSOCIATED SUBSCRIBER DEVICE

(71) Applicant: ERICSSON TELEVISION INC., Duluth, GA (US)

(72) Inventors: Chris Phillips, Hartwell, GA (US); Robert Hammond Forsman, Sugar Hill, GA (US); Jennifer Ann Reynolds, Duluth, GA (US); Charles Hammett Dasher, Lawrenceville, GA (US)

(73) Assignee: ERICSSON TELEVISION INC., Duluth, GA (US)

(21) Appl. No.: 13/888,616

(22) Filed: May 7, 2013

(51) Int. Cl. H04N 21/274

(52) U.S. Cl. CPC H04N 21/274
USPC 725/115

(57) ABSTRACT

A network personal video recorder (NPVR) system, method and associated subscriber device. In one method operating on an NPVR element, a request for playing back a program asset is received from a first subscriber. If the program asset is determined to be in an associated content system, the method includes performing retrieving the program asset's location information from the associated content system, retrieving external media content from at least one of a local media campaign management system and a national media campaign management system wherein the external media content was included in a broadcast transmission of the program asset, building a playlist including the program asset and inserting the external media content into the playlist at appropriate insertion points, and transmitting the playlist including the program asset and the inserted external media content to the first subscriber.

### CROSS-REFERENCE TO RELATED APPLICATION(S)

This application discloses subject matter that is related to the subject matter of the following U.S. patent application: (i) “NETWORK PERSONAL VIDEO RECORDER SYSTEM, METHOD AND ASSOCIATED SUBSCRIBER DEVICE” (Ericsson Ref. No.: P39854-US1), Application Ser. No. ______, filed ______, in the name(s) of Christopher Phillips, Robert Hammond Forsman, Jennifer Ann Reynolds and Charles Hammett Dasher, which is hereby incorporated by reference in its entirety.

### FIELD OF THE DISCLOSURE

The present disclosure generally relates to the management and storage of program assets in an operator network. More particularly, and not by way of any limitation, the present disclosure is directed to a network personal video recorder system, method and associated subscriber device.

### BACKGROUND

Broadcast of entertainment programming content, e.g., TV programs, over broadband communications networks, such as cable networks, satellite networks, etc. is well known. However, to free a user from the traditional constraint of a broadcast schedule, a network operator may also provide the user with Video-On-Demand (VOD) services that allow the user to access selected programming content on an on-demand basis. In addition, the VOD services allow the user to manipulate (e.g., rewind, pause and fast-forward) a VOD presentation to enhance his/her viewing experience. However, the collection of VOD programs from which the user may select is typically compiled by the VOD service provider. Because the user has no input to the compilation of the VOD programs, the user at times may not find any program in the collection to his/her personal liking.

Personalized recording may be a solution to the above-identified VOD service deficiency, which may be achieved using a digital video recorder (DVR), also known as a personal video recorder (PVR), such as, e.g., TiVo® or ReplayTV® device. In some implementations, PVR functionality may be bundled by a network operator within a set-top box for viewing on one or more display devices (e.g., TVs). In general, a PVR/DVR device allows a user or subscriber to record his/her favorite TV programs for subsequent viewing, and may provide an option to record every episode of his/her favorite program for a period (e.g., a TV program season). It may automatically record programs for the user/subscriber based on his/her viewing habit and preferences. It may also automatically record the last X minutes of programming content played on the channel to which the user actually tunes, where X represents a predetermined value. The presentation of the recorded programming content can be manipulated by exercising rewind, pause and fast-forward functions as well. In addition, some PVR/DVRs may provide a “commercial skip” feature or the like, enabling the subscriber to skip commercials when viewing recorded programming content.

A major concern with respect to the PVR/DVR solution described above is how to effectively manage the finite storage capacity of a DVR to accommodate conceivably unlimited programming content recorded by a subscriber. In fact, to improve the DVR's storage capacity and other functionalities over time, the subscriber of a conventional DVR service is faced with continual hardware and software upgrades of the DVR, which can be time-consuming and costly. Yet another significant issue relates to accidentally erasing or deleting the stored programs from the PVR/DVR device of a subscriber.

### SUMMARY

The present patent disclosure is broadly directed to a network personal video recorder (NPVR) system, method and associated subscriber device. In a method embodiment operating at an NPVR element, a request for recording a program asset may be received from a first subscriber. Responsive thereto, the NPVR element verifies whether the requested program asset is available in an external content system associated with the NPVR element. The requested program asset may be recorded in a content database if there is no equivalent copy of the program asset available in the associated external content system or in the NPVR system, e.g., for another subscriber. The present patent disclosure is also directed to associated computer-accessible media, computer programmable products and various software/firmware components relative to the various network-based and device-based processes set forth herein.

In another aspect, an embodiment of a network element or node operable in an NPVR system is disclosed. The claimed NPVR element comprises one or more processors, and a memory subsystem coupled to the one or more processors, wherein the memory subsystem includes a persistent memory (e.g., nonvolatile memory such as Flash memory). The NPVR element includes a record decision logic module configured to be executed by the one or more processors for processing a recording request received from a subscriber with respect to a program asset, wherein the record decision logic module is implemented in the persistent memory and adapted to facilitate recording of the program asset in a content database associated with the NPVR system if there is no equivalent copy of the program asset available in the NPVR system or an associated content system.

In a further aspect, an embodiment of an NPVR element may include a play decision logic module configured to be executed by one or more processors for processing a playback request received from a subscriber. In one embodiment of a method operating on an NPVR element, a request for playing back a program asset is received from a first subscriber. If the program asset is determined to be in an associated content system, the method includes performing retrieving the program asset's location information from the associated content system, retrieving external media content from at least one of a local media campaign management system and a national media campaign management system wherein the external media content was included in a broadcast transmission of the program asset, building a playlist including the program asset and inserting the external media content into the playlist at appropriate insertion points, and transmitting the playlist including the program asset and the inserted external media content to the first subscriber. If the play decision logic module determines that the program asset is not in an associated content system, then the method includes performing determining that the program asset is recorded within the NPVR system for a second subscriber, building a playlist from the program asset recorded for the second subscriber, wherein the playlist includes a start time and an end time based on the second subscriber's recording of the program asset; and transmitting the playlist including the program asset to the first subscriber. In a still further aspect, an embodiment of a non-transitory computer-readable medium containing instructions stored thereon is disclosed. When the stored instructions are executed by a computer system configured to operate as an NPVR element, the computer system is operable to perform one or more method embodiments set forth above.

In a further aspect, an embodiment of a subscriber device configured to operate with a network node disposed in an NPVR system is disclosed. The claimed subscriber device comprises one or more processors and a memory subsystem coupled thereto, wherein the memory subsystem includes a persistent memory. Computer program instructions may be stored in the persistent memory, wherein the instructions are configured to: facilitate generation and transmission of a request to the network node to restore a program asset that was locally stored on the subscriber device; facilitate processing of the program asset received from the network node in a playlist via at least one of a managed delivery network and an unmanaged delivery network, wherein the program asset is built into the playlist by the network node based on at least one of: (i) a recording of the program asset in the NPVR system for a subscriber other than a subscriber associated with the subscriber device, (ii) a recording of the program asset in the NPVR system for the subscriber associated with the subscriber device; and (iii) if the program asset exists in a content system associated with the network node, retrieving the program asset's location information from the associated content system and selectively inserting any external media content at appropriate insertion points; and restore the program asset on the subscriber device.

In a further aspect, yet another embodiment of a subscriber device includes a persistent memory having computer program instructions stored therein, the instructions configured to: facilitate generation and transmission of a request to the network node to play back a program asset, the request including a start time for playing back the program asset; facilitate processing of the program asset received from the network node in a playlist via at least one of a managed delivery network and an unmanaged delivery network, wherein the program asset is built into the playlist by the network node based on at least one of (i) a recording of the program asset in the NPVR system for a subscriber other than a subscriber associated with the subscriber device, (ii) a recording of the program asset in the NPVR system for the subscriber associated with the subscriber device; and (iii) if the program asset exists in a content system associated with the network node, retrieving the program asset's location information from the associated content system and selectively inserting any external media content at appropriate insertion points; and play the program asset on the subscriber device at the start time indicated in the request.

In a still further aspect, an embodiment of a method performed in or at a subscriber device is disclosed, wherein the subscriber device is configured to operate with a network node disposed in an NPVR system. The claimed method comprises generating and transmitting a request to the network node to restore a program asset that was locally stored on the subscriber device; receiving the program asset from the network node in a playlist via at least one of a managed delivery network and an unmanaged delivery network, wherein the program asset is built into the playlist by the network node based on at least one of: (i) a recording of the program asset in the NPVR system for a subscriber other than a subscriber associated with the subscriber device, (ii) a recording of the program asset in the NPVR system for the subscriber associated with the subscriber device; and (iii) if the program asset exists in a content system associated with the network node, retrieving the program asset's location information from the associated content system and selectively inserting any external media content at appropriate insertion points; and restoring the program asset on subscriber device.

Further features of the various embodiments are as claimed in the dependent claims.

As will be explained in further detail hereinbelow, one or more of the embodiments of the present disclosure aim to address at least some of the concerns set forth in the foregoing background section, inter a/ia. For instance, one or more embodiments of the present disclosure may advantageously obviate the need for continual hardware and software upgrades of a local PVR/DVR solution. In addition, one or more embodiments may beneficially reduce network-based storage required in conventional network PVR (i.e., NPVR) implementations. In certain other embodiments, recovery of locally deleted or erased program content may be advantageously provided. Various additional benefits and advantages will be apparent in view of the following description and accompanying Figures.

### BRIEF DESCRIPTION OF THE DRAWINGS

Embodiments of the present disclosure are illustrated by way of example, and not by way of limitation, in the Figures of the accompanying drawings in which like references indicate similar elements. It should be noted that different references to “an” or “one” embodiment in this disclosure are not necessarily to the same embodiment, and such references may mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

The accompanying drawings are incorporated into and form a part of the specification to illustrate one or more exemplary embodiments of the present disclosure. Various advantages and features of the disclosure will be understood from the following Detailed Description taken in connection with the appended claims and with reference to the attached drawing Figures in which:

FIG. 1 depicts an example network environment that includes an embodiment of a network personal video recorder (NPVR) system of the present patent application;

FIG. 2 depicts a block diagram of a network node adapted to operate in an NPVR system according to an embodiment of the present patent disclosure;

FIG. 3A depicts a flowchart pertaining to a sequence of events that may occur according to an embodiment of a method with respect to processing a recording request at an NPVR node of the present patent disclosure;

FIG. 3B depicts a flowchart pertaining to a sequence of events that may occur according to an embodiment of a method with respect to processing a playback request at an NPVR node of the present patent disclosure;

FIG. 4 depicts additional network elements with which an NPVR system is adapted to operate with respect to processing a recording request according to an embodiment of the present patent application;

FIG. 5 depicts a flowchart with additional details with respect to processing a recording request according to an embodiment of the present patent application;

FIG. 6 depicts additional network elements with which an NPVR system is adapted to operate with respect to processing a playback request or a restoration request according to an embodiment of the present patent application;

FIG. 7 depicts a flowchart with additional details with respect to processing a playback request according to an embodiment of the present patent application;

FIGS. 8A and 8B depict flowcharts pertaining to sequences of events that may occur at a subscriber device according to one or more embodiments of the present patent disclosure; and

FIG. 9 depicts a block diagram of an example subscriber device adapted to operate with an NPVR system according to an embodiment of the present patent disclosure.

### DETAILED DESCRIPTION OF THE DRAWINGS

In the following description, numerous specific details are set forth with respect to one or more embodiments of the present patent disclosure. However, it should be understood that one or more embodiments may be practiced without such specific details. In other instances, well-known circuits, subsystems, components, structures and techniques have not been shown in detail in order not to obscure the understanding of the example embodiments. Accordingly, it will be appreciated by one skilled in the art that the embodiments of the present disclosure may be practiced without such specific details. It should be further recognized that those of ordinary skill in the art, with the aid of the Detailed Description set forth herein and taking reference to the accompanying drawings, will be able to make and use one or more embodiments without undue experimentation.

Additionally, terms such as “coupled” and “connected,” along with their derivatives, may be used in the following description, claims, or both. It should be understood that these terms are not necessarily intended as synonyms for each other. “Coupled” may be used to indicate that two or more elements, which may or may not be in direct physical or electrical contact with each other, co-operate or interact with each other. “Connected” may be used to indicate the establishment of communication, i.e., a communicative relationship, between two or more elements that are coupled with each other. Further, in one or more example embodiments set forth herein, generally speaking, an element, component or module may be configured to perform a function if the element is capable of performing or otherwise structurally arranged to perform that function.

As used herein, a network element may be comprised of one or more pieces of service network equipment, including hardware and software that communicatively interconnects other equipment on a network (e.g., other network elements, end stations, etc.), and is adapted to host one or more applications or services with respect to a plurality of subscribers. Some network elements may comprise “multiple services network elements” that provide support for multiple networking functions (e.g., A/V media management, session control, Quality of Service, and/or subscriber management, and the like), in addition to providing support for multiple application services (e.g., data and multimedia applications). Subscriber end stations (e.g., set-top boxes, PVR/DVRs, servers, workstations, laptops, netbooks, palm tops, mobile phones, smartphones, multimedia phones, Voice Over Internet Protocol (VOIP) phones, user equipment, terminals, portable media players, location-aware subscriber equipment, gaming systems or consoles, etc.) may access or consume content/services provided over broadcast networks (e.g., cable and satellite networks) as well as a packet-switched wide area public network such as the Internet via suitable service provider access networks. Subscriber end stations may also access or consume content/services provided on virtual private networks (VPNs) overlaid on (e.g., tunneled through) the Internet.

One or more embodiments of the present patent disclosure may be implemented using different combinations of software, firmware, and/or hardware. Thus, one or more of the techniques shown in the Figures (e.g., flowcharts) may be implemented using code and data stored and executed on one or more electronic devices or nodes (e.g., a subscriber device or end station, a network element, etc.). Such electronic devices may store and communicate (internally and/or with other electronic devices over a network) code and data using computer-readable media, such as non-transitory computer-readable storage media (e.g., magnetic disks, optical disks, random access memory, read-only memory, flash memory devices, phase-change memory, etc.), transitory computer-readable transmission media (e.g., electrical, optical, acoustical or other form of propagated signals—such as carrier waves, infrared signals, digital signals), etc. In addition, such electronic devices may typically include a set of one or more processors coupled to one or more other components, such as one or more storage devices (non-transitory machine-readable storage media), user input/output devices (e.g., a keyboard, a touch screen, a pointing device, and/or a display), and network connections. The coupling of the set of processors and other components may be typically through one or more buses and bridges (also termed as bus controllers), arranged in any known (e.g., symmetric/shared multiprocessing) or heretofore unknown architectures. Thus, the storage device or component of a given electronic device may be configured to store code and/or data for execution on one or more processors of that electronic device for purposes of implementing one or more techniques of the present disclosure.

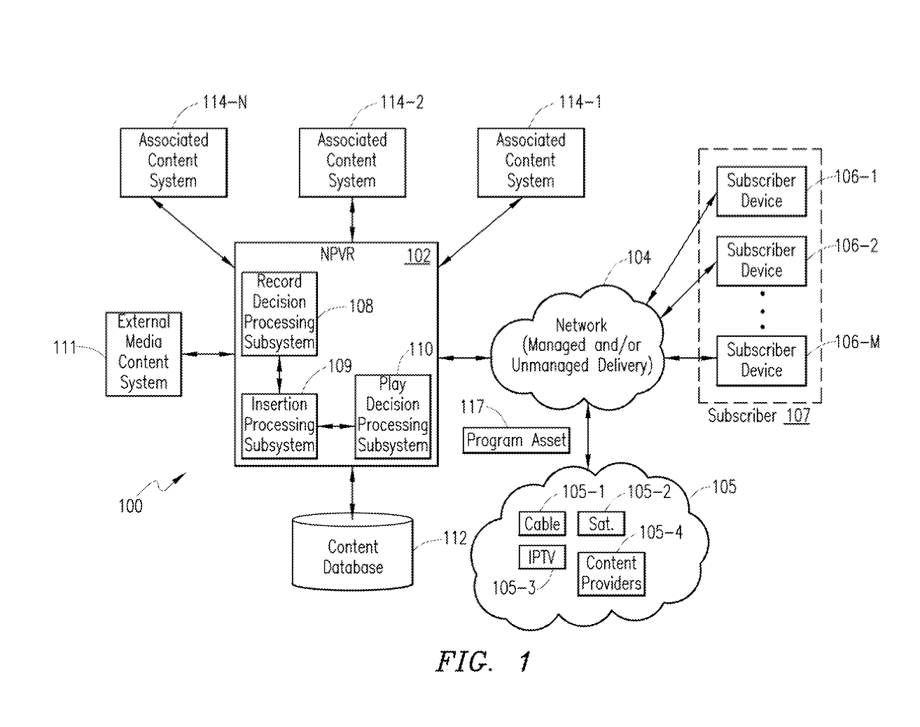

Referring now to the drawings and more particularly to FIG. 1, depicted therein is an example network environment that includes an embodiment of an NPVR system 100 of the present patent application for providing intelligent or “smart” recording and playback capabilities with respect to any known or heretofore unknown digital assets or program assets for a number of subscribers. For purposes of the present patent application, the terms “digital asset” and “program asset” are roughly overlapping, and may include any type of audio/video content or program segment having a start time and an end time such as live and/or recorded over-the-air free network television (TV) shows or programs, pay TV broadcast programs via cable networks or satellite networks, free-to-air satellite TV shows, IPTV programs, Over-The-Top (OTT) and on-demand shows or programs as well as other content assets provided by content owners or providers, including but not limited to newscasts, sportscasts, online electronic games, radio shows, entertainment programs, weather programs, educational programs, movies, specialty infomercials or documentary programs, ethnic programs in different languages, music video programs, and the like. Further, program assets may comprise shows that are transmitted “live” or rerun (i.e., recorded), whether broadcast in free channels, fee-based pay channels, or both. Such program assets may also include any type of external media content that is inserted into a transmission of the program asset, e.g., national and/or local commercials or ads, local alert broadcasts, etc. Reference numeral 117 refers to a representative program asset that may be broadcast or otherwise transmitted to subscribers in a geographic region or market, e.g., a subscriber 107, for reception on any number of subscriber devices 106-1 to 106-M associated therewith, depending on the technology and delivery infrastructure involved. For example, analog TV program streams may be formatted according to the National Television Standards Committee (NTSC) or PAL broadcast standard and may be broadcast via legacy cable network systems. Digital TV program streams may be formatted according to the Digital Satellite System (DSS), Digital Broadcast Services (DBS), or Advanced Television Standards Committee (ATSC) standard, and may comprise normal definition, high definition as well as ultra high definition and/or 3D programming. Further, program assets may be transmitted by RF, microwaves or other spectral bands in a broadcast fashion to all consumer appliances or subscriber devices within the range of coverage of the transmitting tower(s) or satellite(s), wherein such broadcast signals may comprise ATSC compliant terrestrial broadcast signals, other terrestrial broadcast signals, such as DVB-T or DVB-H compliant signals and other types of wired, wireless or satellite broadcast signals such as DVB-S, DVB-S2 and DVB-C compliant signals. Transmission of program assets can also be achieved by the following standards: IEEE 802.11a/b/g or 802.11n (WiFi), 802.16e (WiMAX), LTE, COMA, GSM, TDMA, etc. Program assets may also be transmitted to the subscribers in a variety of web OTT or telco OTT infrastructures, for example over packet-switched networks or overlays using adaptive bitrate streaming techniques. Accordingly, reference numeral 105 broadly refers to a plurality of infrastructures, e.g., cable system (coaxial and hybrid fiber coaxial (HFC)) infrastructures 105-1, satellite TV infrastructures 105-2, IPTV infrastructures 105-3 as well as other content delivery infrastructures 105-4, each of which may use any combination of access and/or transmission networks 104 for effectuating an end-to-end managed delivery network or an unmanaged delivery network with respect to a variety of program assets 117 delivered to subscribers 107. By way of further illustration, subscriber devices 106-1 to 106-M may comprise appliances that not only receive program assets for live viewing, playback and/or rendering, but also operate as command consoles that can accept user inputs, commands or requests to interact with an network element disposed in the NPVR system 100 (e.g., NPVR element 102). Additionally, some of the subscriber devices may also function as local servers, i.e., which receive and store program assets for later transfer to yet other appliances for additional local storage, playback and/or rendering. Accordingly, as pointed out earlier, example subscriber devices may include TVs, PCs, laptops, notebook computers, tablets, discrete set top boxes (STBs), virtual STBs, integrated TV/STBs, PVRs/DVRs, smartphones, smart TVs, gaming consoles (such as the Wii®, Play Station 3®, Xbox 360®), and the like.

Example NPVR element 102 may be implemented as one or more individual hardware/software platforms that may be co-located or otherwise integrated into a single network element or node. In other implementations, NPVR element 102 may be provided as distributed equipment that logically functions as a single network node. Regardless of the specific implementation, NPVR element 102 includes suitable hardware/software modules or blocks forming a record decision processing subsystem 108, an external media insertion processing subsystem 109 and a play decision processing subsystem 110, in addition to having appropriate interfaces for effectuating communication with one or more associated content systems 114-1 to 114-N as well as external media content systems 111 such as repositories of national and/or local commercials, alert bulletins, etc. A database system 112, which may be centralized, distributed, hierarchically organized, or arranged otherwise in any known or heretofore unknown architectures may be provided to interface with the NPVR element 102 as part of the example NPVR system 100. It should be appreciated by one skilled in the art that although the term “NPVR” is used herein, it is not a necessary requirement that the NPVR system 100 record or otherwise capture all in-progress programs, previously broadcast programs and future programs as may be done in a conventional NPVR service implemented at a network operator's headend. Rather, as will be described in additional detail below, the broad functionality of the NPVR system 100 of present patent disclosure involves intelligent management of subscriber requests to record program assets wherein an asset may be recorded only when there is no copy of the program asset or its equivalent available within the NPVR system 100 or an associated external content system such as content systems 114-1 to 114-N. For purposes of the present patent disclosure, a copy or an equivalent copy of a program asset may be any copy, however stored, recorded, captured, encoded, encrypted, modified or compressed, which can be retrieved or located in any suitable manner, either in the NPVR system, associated external content system or in any combination thereof. Intelligent playback decision logic may be provided to appropriately process subscriber requests to play back or render program assets even where a subscriber's prior request for recording a program asset did not actually cause recording of the requested program asset in the NPVR system 100.

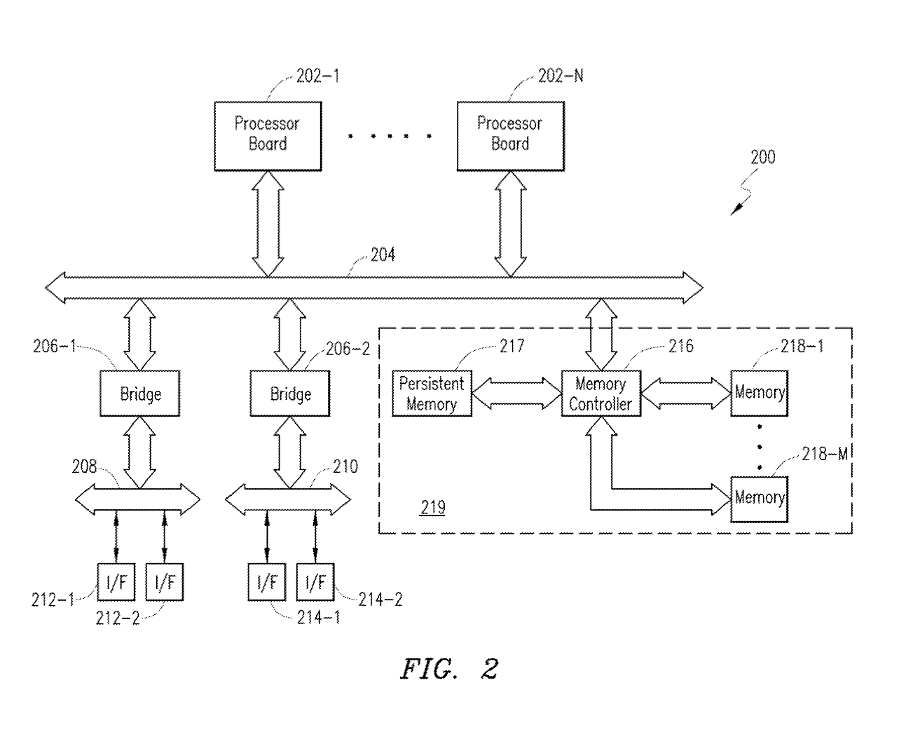

FIG. 2 depicts a block diagram of a network node 200 adapted to operate as example NPVR element 102 in the NPVR system 100 according to an embodiment of the present patent disclosure. One or more processors or processor boards 202-1 to 202-N coupled to a bus structure 204 provide for the overall control of the NPVR node 200, including executing suitable decision logic configured to process subscriber requests for recording and/or playback of program assets. Bus 204 may be coupled to one or more bus bridges or bus controllers 206-1, 206-2 for extending to or coupling to additional or peripheral buses 208, 210, which in turn may support a plurality of interfaces (I/F). One or more of such interfaces may effectuate interfacing with internal and external databases, external content systems, e.g., time-shifted TV systems (TSTV), various Video-On-Demand (VOD) systems including movie-on-demand (MOD) services, subscription VOD (SVOD) services, etc., OTT systems including third-party content providers such as Netflix®, Hulu®, or myTV, as well as IPTV providers, in addition to national/local media campaign systems or repositories of commercials, alerts, bulletins, and the like. Additionally, one or more of such interfaces may also provide appropriate connectivity between the NPVR element 200 and various cable and satellite TV infrastructures exemplified in FIG. 1. Still further, such interfaces may also effectuate connectivity to managed and/or unmanaged delivery networks for 2-way communications with subscriber devices. Accordingly, interfaces 212-1/212-2 and 214-1/214-2 may include or operate in association with audio and/or video encoders, decoders, modulators/demodulators, formatters, MPEG compression modules, transcoders, etc.

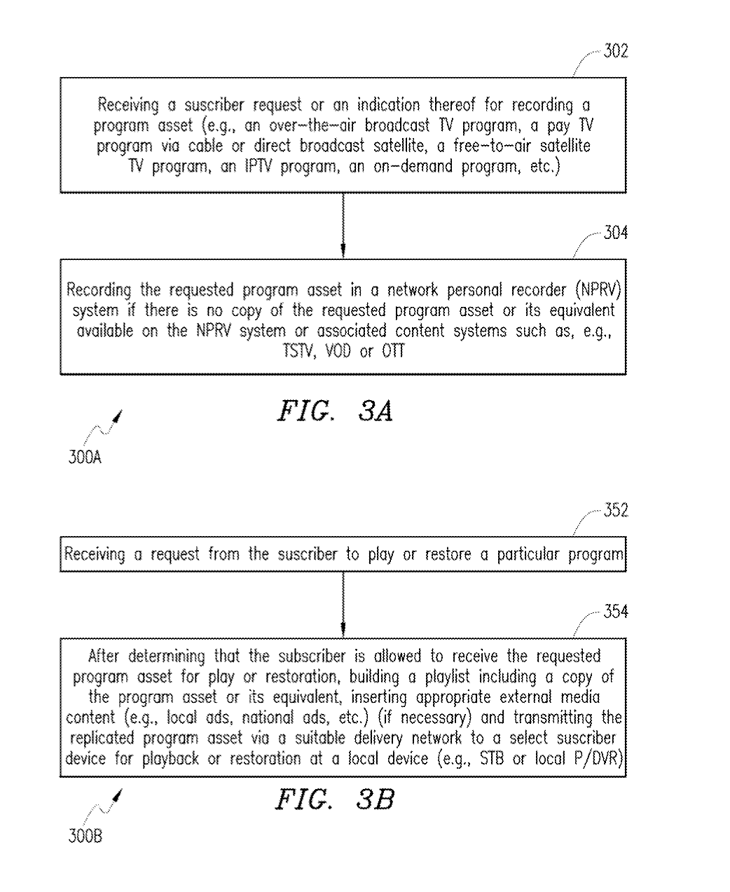

A memory subsystem 219 provided with the network node 200 may include one or more memory controllers 216 for controlling memory operations relative to a plurality of memory modules 218-1 to 218-M as well as nonvolatile memory modules such as persistent memory module 217. In accordance with the teachings of the present disclosure, program instructions, which may be organized and/or executed as one or more software processes, modules, blocks, routines, threads, etc. may be stored in or uploaded/downloaded into the persistent memory 217 for effectuating decision logic relative to processing subscriber requests for recording, playback, or both. FIG. 3A depicts a flowchart pertaining to a sequence of events that may occur according to an embodiment of a method 300A with respect to processing a recording request at an NPVR node, e.g., network node 200, of the present patent disclosure. A non-transitory computer-readable medium containing instructions thereon may be embodied as a persistent memory module, which instructions may be executed to effectuate the events at the network node 200. A request for recording a program asset may be received from a first subscriber over a suitable transmission network, e.g., a managed network or an unmanaged network, wherein the request may be generated by and/or at a particular customer equipment device associated with the first subscriber (block 302). Such a request may be made during a program asset's live transmission, in a recorded or time-delayed transmission, or in advance of the broadcast of the program asset, or at some other time. Further, such a request may include additional parameters relevant to recording the program asset, e.g., start and end times, playback options/controls or settings therefor, etc. Request processing logic embodied in the persistent memory is adapted to verify if there is no copy (or its equivalent) of the program asset available in the NPVR system's database and on any of the external content systems associated with the NPRV system, such as, e.g., TSTV, VOD and OTT systems. If so, the requested program asset may be recorded or stored in the NPVR database using any suitable format (e.g., encrypted, encoded, compressed, and/or processed to remove commercials, etc.), along with the subscriber information and recording parameters (block 304). If the requested content, i.e., the program asset, already exists on the associated TSTV/VOD/OTT systems, the processing logic is further adapted to make a note, indication, or some other indicium, within the NPVR system that the requesting subscriber has the rights to use the content (i.e., view the content for free), in addition to storing when the recording request was made. As will be described in additional detail hereinbelow, appropriate insertion points for external media (e.g., national/local commercials) may also be noted by the NPVR node such that a playlist including the program asset and any local/national commercials may be built or rebuilt responsive to a playback request.

FIG. 3B depicts a flowchart pertaining to a sequence of events that may occur according to an embodiment of a method 3006 with respect to processing at the NPVR node 200 a playback request or a request to restore a previously recorded program asset. Similar to the recording request processing logic described above, a non-transitory computer-readable medium containing instructions thereon may be embodied as a persistent memory module, which instructions may be executed to effectuate the various events at the network node 200 responsive to subscriber requests. For instance, a request for playing back a program asset may be received from a subscriber over a suitable transmission network, e.g., a managed network or an unmanaged network, wherein the request may be generated by and/or at a particular customer equipment device associated with the subscriber (block 352). Alternatively or additionally, a subscriber may generate a request to restore a program asset that was previously recorded at a local subscriber device, e.g., a PVR or DVR, which recording event was logged or otherwise noted at the NPVR node 200 (block 352). Upon receiving a playback request or restoration request from the subscriber, request processing logic embodied in the persistent memory is adapted to verify that the subscriber is allowed to receive or restore the requested program asset (e.g., because the subscriber previously made a legitimate recording request therefor within appropriate licensing windows and therefore has the rights to the content) (block 354). The processing logic is further adapted to build a playlist using a copy of the program asset or its equivalent, which may be a recording made for a different subscriber or is available from a location at one of the associated external content systems, wherein appropriate external media content, e.g., local/national media campaign content, may be inserted based on the relevant insertion points. Depending on where the program asset content is retrieved from, suitable transcoding may be necessary in some implementations. After the playlist is built (or, replicated), it may be transmitted via a suitable delivery network to a select subscriber device for playback or downloaded to a local subscriber device, e.g., a PVR/DVR or a set top box, where the program asset was previously stored but deleted for whatever reason. These additional acts or operations are also illustrated in block 354.

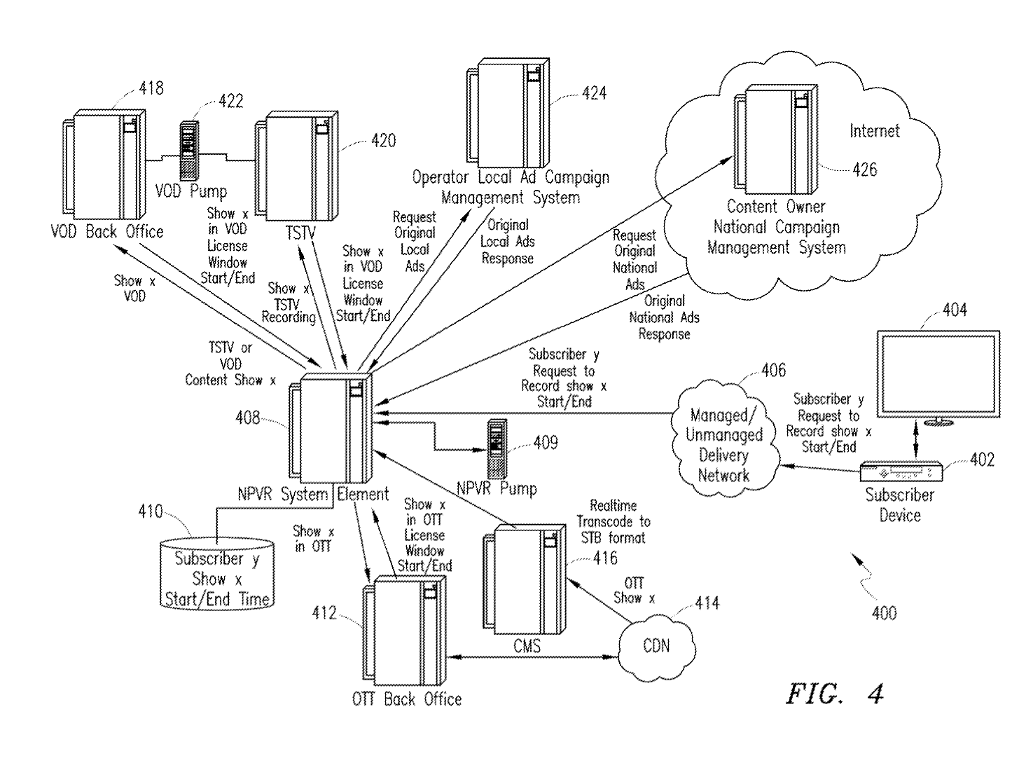

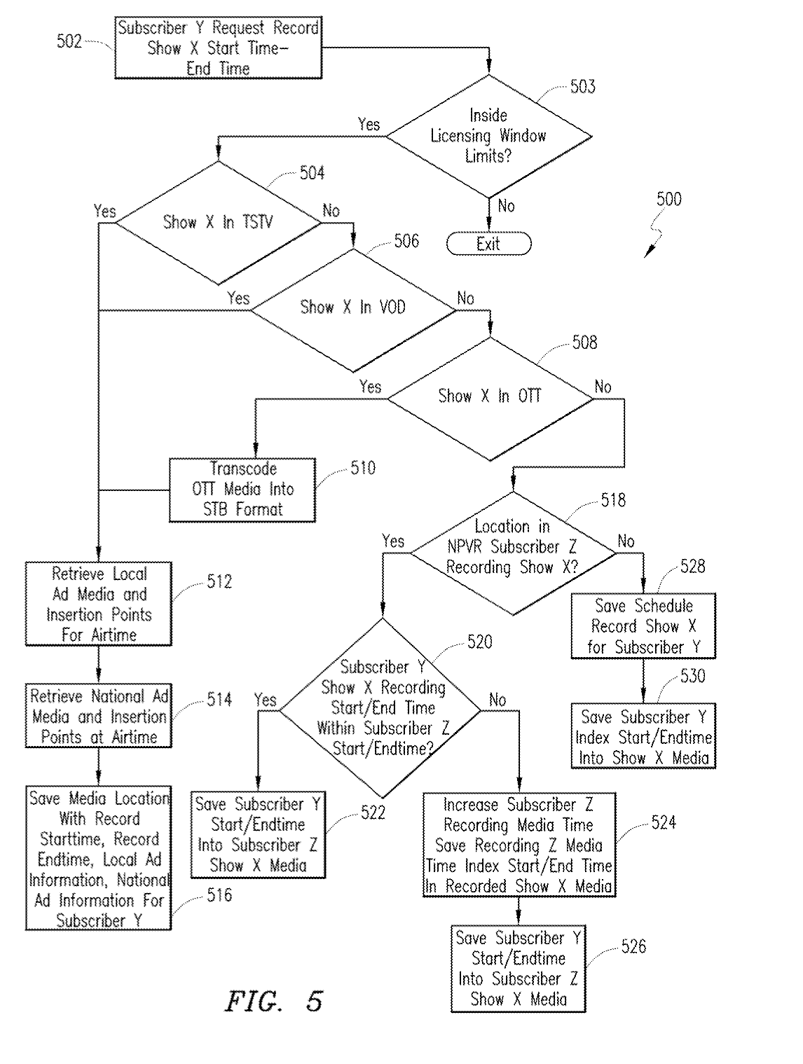

Referring now to FIG. 4, depicted therein is an end-to-end network environment 400 that illustrates various interactions among a plurality of entities, elements, nodes, components, or network portions with respect to processing recording requests from subscribers according to an embodiment of the present patent application. FIG. 5 depicts a flowchart with additional details with respect to a methodology 500 for processing a recording request according to an embodiment of the present patent application. Taking FIGS. 4 and 5 together, reference numeral 402 refers to a representative subscriber device associated with a subscriber (e.g., subscriber devices 106-1 to 106-N shown in FIG. 1) that is coupled to a TV or other suitable display device 404. Subscriber device 402 may be activated by using input keys, pads, knobs, or touch screens provided thereat or by way of a handheld remote control device, and may be coupled to one or more managed delivery networks as well as one or more unmanaged delivery networks (cumulatively exemplified as network 406) via a home gateway that may be adapted for providing unified command, control and delivery relative to a number of subscriber devices. Accordingly, subscriber device 402 may be exemplary of an end station operable to accept traditional DOCSIS (Data over Cable Service Interface Specification), DOCSIS Set-Top Gateway (DSG), broadcast QAM, switched digital video QAM, VOD over QAM, and even analog channels, as well as broadband IP streams overlaid over satellite, cellular/wireless telephony, wired telephony (e.g., DSL), fiber to premises, and cable networks with guaranteed/dedicated bandwidth delivery. A first subscriber (e.g., Subscriber Y) may manipulate or otherwise interact with subscriber device 402 in order to enter a request to record a program asset (e.g., Show X) along with the start and end times for recording (block 502). As pointed out previously, such a request may include additional parameters, indicators, etc. (e.g., temporal (time/day) information, parental controls, and the like). The request to record may be transmitted via network infrastructure 406 to an NPVR system element 408 that may be associated with an NPVR pump 409 adapted to manage media streams using suitable modulation techniques, A/V coding/compression schemes, and the like, for providing managed streams to the subscriber devices. In one implementation, NPVR system element 408 may be configured and adapted to function as the network node 102 or 200 described hereinabove. Decision logic operating at or in association with NPVR element 408 is operable to determine if the requested program asset is within applicable licensing window limits (block 503), which may be set by the provider/originator of the program asset (i.e., content providers or suppliers). As one skilled in the art may appreciate, network operators (e.g., cable operators including multiple systems operators (MSOs) and multiple network operators (MNOs)) may be subject to such licensing limits, which may affect the operator's ability with respect to providing or accessing TSTV, VOD, OTT or place-shifted TV services for subscribers. If the requested program asset for recording is within the applicable licensing windows, a sequence of determinations may be made by the decision logic operating at or in association with NPVR element 408 as to whether the program asset is within any associated external content system such as a TSTV system 420, a VOD system 418, or an OTT system 412. Decision blocks 504, 506 and 508 are representative of such determinations, respectively. It should be appreciated that such determinations may be made in any interchangeable order (i.e., the TSTV determination 504 may be executed after the VOD determination 506 or the OTT determination 508). If the requested program asset is within the OTT system, such content may need to be transcoded into a format (block 510) that is appropriate for the subscriber device 402 (i.e., a subscriber's STB) and may involve a suitable content management system (CMS) 416 operating in connection with a content delivery network (CDN) 414.

After determining that a copy or equivalent of the requested program asset exists in an associated TSTV or OTT or VOD system, the decision logic operating at or in association with NPVR element 408 may retrieve insertion points for external media content that is (or was or will be) included in a broadcast transmission of the program asset. For purposes of the present patent application, a “broadcast transmission” may involve transmission over free cable/satellite channels, fee-based pay channels in cable/satellite channels, IPTV channels, or any combination thereof. In one implementation, retrieval of insertion points may involve suitable request/response messaging sessions between the NPVR element 408 and national and/or local media ad campaign content owners over a public packet-switched wide area IP network (i.e., the Internet) as well as any intranets, extranets, enterprise networks, and the like. Reference numerals 424 and 426 are representative of local ad campaign and national ad campaign management systems from which appropriate insertion points for local ads (block 512) and national ads (block 514) may be retrieved for purposes of the present patent disclosure. The decision logic is operable to save the media location (i.e., the location at a specific external content system where the requested program content or a copy thereof exists) as well as applicable data or metadata (e.g., recording start/end times, local/national ad insertion information, etc.) into a subscriber data record associated with the requesting subscriber in an NPVR database 410, as set forth at block 516. It should be appreciated that certain external content systems such as TSTV and VOD systems may include a back office containing records pertaining to the program media but not the media content itself, and such systems may be provided with a VOD pump 422 that actually stores the program media. Accordingly, in certain implementations, media location retrieval and storage that is executed responsive to the subscriber's request to record a particular show may involve saving all appropriate location pointers/indices, regardless of how hierarchically organized, stored or distributed a particular show may be in the external content systems.

Continuing to refer to FIG. 5, if the decision logic operating at or in association with NPVR element 408 determines that a copy or equivalent of the requested program asset does not exist in the associated TSTV system 420, or OTT system 412, or VOD system 418, a still further determination is made at block 518 to determine if the program asset exists within the NPVR system (i.e., already recorded or otherwise stored) for another subscriber (Le,, a second subscriber or Subscriber Z). If so, appropriate timing pointers corresponding to the first subscriber's requested start/end times for recording may be indexed or otherwise provided in reference to the program asset already recorded/stored at the NPVR system. It should be realized that where a program asset already exists within the NPVR system's database(s), the decision logic may maintain in one implementation a set of data records for each requesting subscriber such that a data record may identify timing pointers corresponding to the requesting subscriber's own recording start/end times relative to the program asset's beginning and ending. Furthermore, if the program asset has been stored without local and/or national ads, appropriate ad insertion points may be stored separately, which may be made available commonly with respect to all requesting subscribers. In another implementation, the decision logic may appropriately manage the recording start/end times as different subscribers make recording requests at various times with respect to a program asset. For instance, a decision may be made whether the first subscriber's recording start/end times are within the second subscriber's start/end times associated with the program asset (block 520). If so, the first subscribers start/end times may be indexed or saved into the second subscriber's recording of the program asset (block 522). Otherwise, the second subscribers recording times may be extended, increased or otherwise manipulated with respect to the program asset and the first subscribers start/end times may then be indexed relative thereto, as set forth at block 524 and 526. One skilled in the art will recognize upon reference hereto that a number of variations may be implemented as to how to manage the recording timing pointers for a plurality of subscribers (i.e., sets of {T_{S1}, T_{S2}, . . . , T_{SN}} and {T_{E1}, T_{E2}, . . . , T_{EN}}, where T_{Si} and T_{Ei}, i=1, 2, . . . , N are starting and ending times for N subscribers) relative to a particular show that already exists within the NPVR system.

If the NPVR decision logic determines that the requested program asset does not already exist in the NPVR system for another subscriber (block 518), the program asset may be stored or recorded for the first subscriber (block 528). Further, the requested recording start/end time schedule for the first subscriber may be indexed relative to the stored program asset as set forth at block 530, which may be used for referencing subsequent recording requests from other subscribers.

Although the foregoing description illustrates a recording request that explicitly includes recording start/end times indicated by a subscriber relative to a program asset, it should be appreciated that in some implementations it is not necessary to include such data, for the NPVR system may already have the information as to the starting and ending times of a program or show. Additionally, the NPVR system and one or more external content systems (i.e., TSTV, VOD or OTT systems) may be operated by a single operator or by multiple operators under applicable licensing arrangements with the content providers.

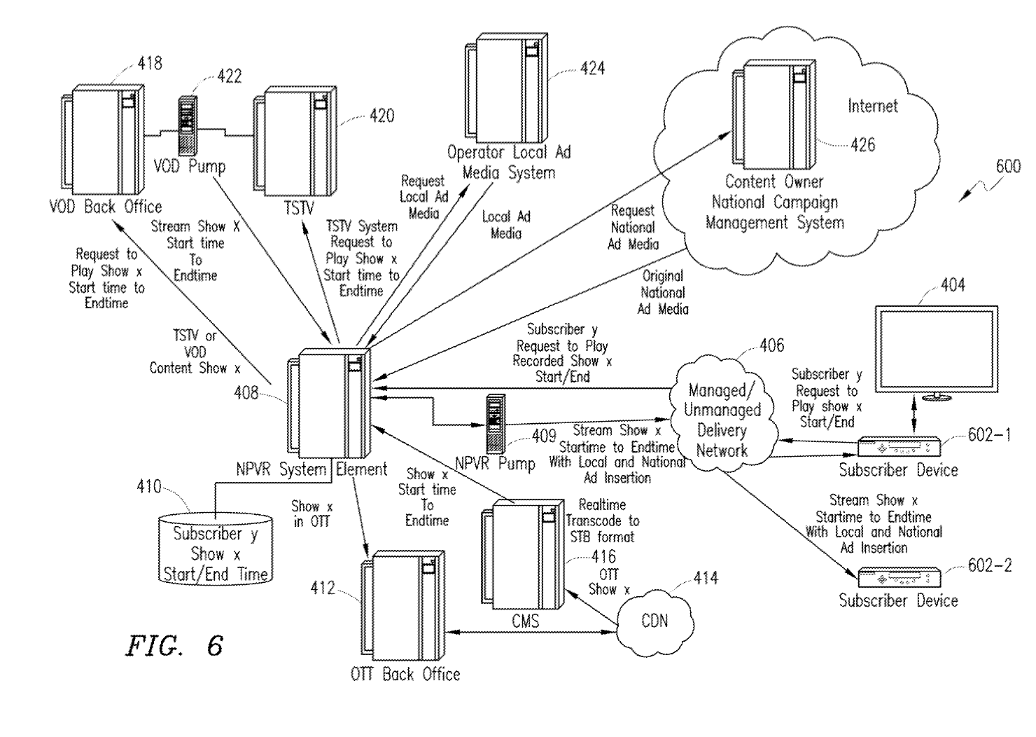

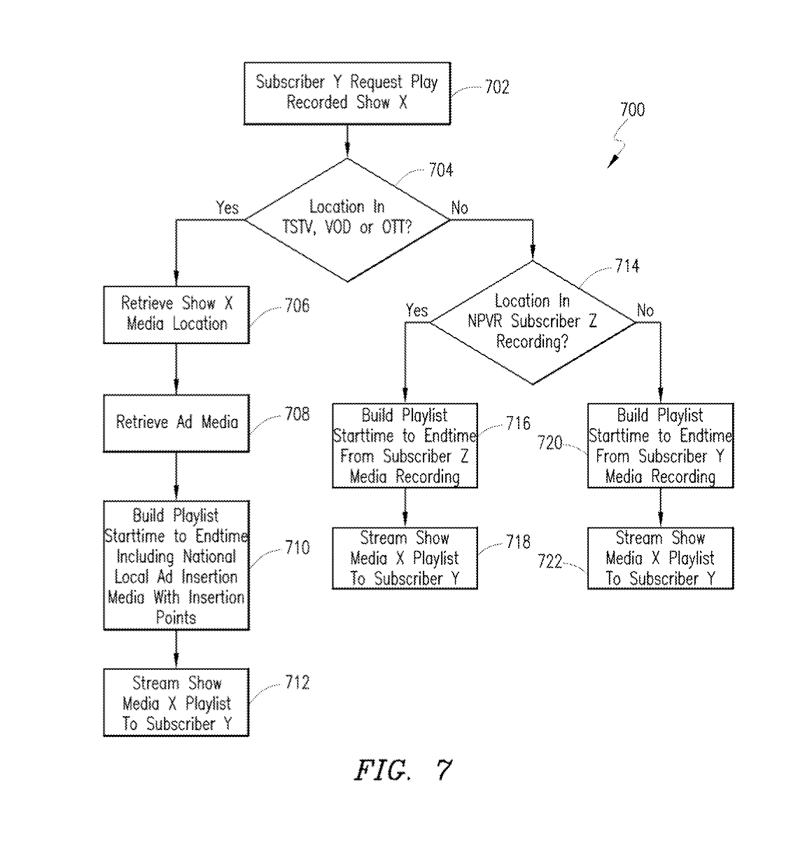

Referring now to FIG. 6, depicted therein is an end-to-end network environment 600 that illustrates various interactions among a plurality of entities, elements, nodes, components, or network portions with respect to processing playback/restoration requests from subscribers according to an embodiment of the present patent application. FIG. 7 depicts a flowchart with additional details with respect to a methodology 700 for processing a playback request according to an embodiment of the present patent application. Because the network environment 600 is substantially identical to the network environment 400 described above, details regarding the various components thereof will not be repeated except in reference to describing the playback decision methodology 700 while taking FIGS. 6 and 7 together. As shown in FIG. 6, a subscriber (e.g., a first subscriber) may generate a request to play back a program asset (e.g., Show X), which request may be generated at a first subscriber device 602-1 but may include an indication as to a different target device (602-2) where the program asset is to be played. Similar to a recording request, such a playback request may be transmitted via the network 406 to the NPVR system element 408 (block 702). In one variation, the requested program asset may have been previously requested for recording by the first subscriber at the NPVR system, similar to the recording process set forth hereinabove. In a further variation, the requested program asset may have been previously requested for recording by the first subscriber at a local device, such as a local PVR/DVR, for example. Appropriate decision logic operating at or in association with NPVR element 408 is operative to determine (block 704) if a copy or equivalent of the requested program asset exists at a location in the associated TSTV system 420, or OTT system 412, or VOD system 418. If so, the decision logic is configured to retrieve the program asset's location information from the appropriate content system (block 706). Further, external media content (i.e., local and/or national media campaign content, and the like) included in the broadcast transmission of the program asset is retrieved (block 708) from local and national campaign management systems 424, 426. A playlist is then built for the program asset based on the start/end times associated therewith for the first subscriber, wherein local and/or national media campaign content is inserted at suitable insertion points (block 710). After the playlist including the program asset and applicable ads is built, it is streamed in association with the NPVR pump 409 to the first subscriber (block 712) via the delivery network 406. As pointed out previously, the playlist may be delivered to a different subscriber device for playback and/or rendering thereat, to the same subscriber device where the playback request was made, or both. Further, the playlist may be delivered using either a managed delivery network portion or an unmanaged delivery network portion, and at a scheduled time requested by the subscriber (i.e., instead of playing back immediately, the playlist may be delivered at a future time).

If the program asset is not in an associated external content system, as determined at block 704, a further determination is made (block 714) as to whether the program asset is recorded within a database of the NPVR system for a second subscriber (i.e., Subscriber Z). If so, a playlist is built from the second subscriber's recording of the program asset (block 716). In one implementation, the playlist may include a start time and an end time based on the second subscriber's recording request. In another variation, the playlist may include a start time and an end time based on the first subscribees record timing parameters indexed into the second subscriber's recording of the program asset. Thereafter, the playlist including the program asset is transmitted (e.g., streaming) in association with the NPVR pump 409 to the first subscriber's device over the appropriate delivery network 406, as set forth at block 718. If the program asset is not recorded within the NPVR system for the second subscriber, as determined at block 714, a playlist is built from the first subscriber's recording of the program asset within the NPVR system (block 720). Thereafter, the playlist including the program asset is transmitted (block 722) to the first subscriber at the scheduled playback time and/or to the indicated subscriber device over the appropriate delivery network 406.

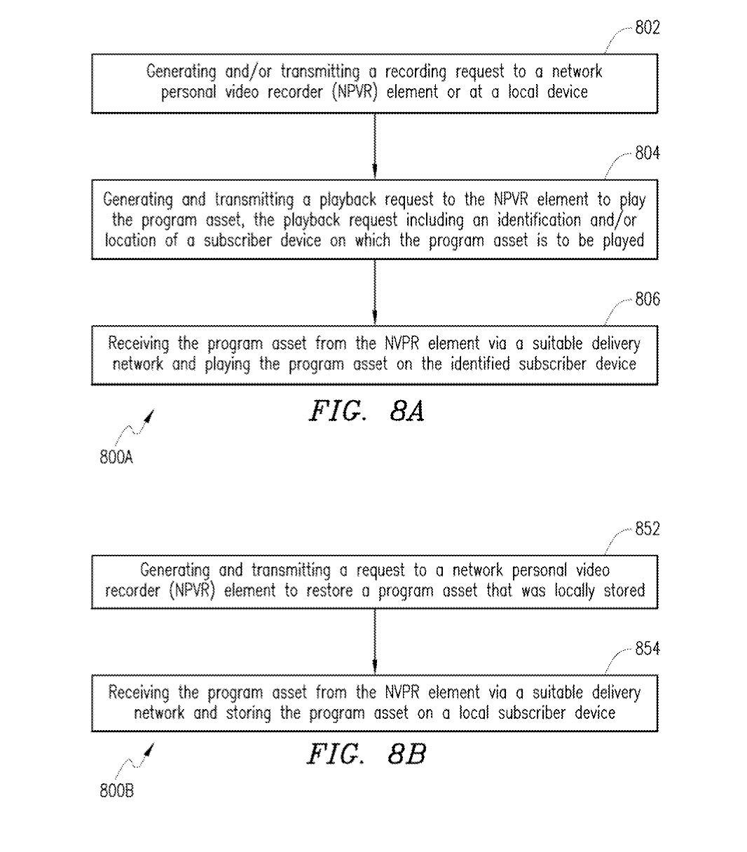

FIGS. 8A and 8B depict flowcharts pertaining to sequences of actions/operations that may occur at a subscriber device according to one or more embodiments of the present patent disclosure. As will be apparent to one skilled in the art, the sequences of actions/operations may be effectuated at the subscriber device in conjunction with appropriate hardware, software and/or firmware elements and subsystems, and may involve executing program instructions stored in a persistent memory of the subscriber device. Further, such actions/operations may involve one or more user input(s) for real-time execution or for future execution, although such user input is not always necessary and may be controlled by subscriber profile based events and/or operator-defined triggering events in a fairly autonomous manner. In one embodiment, a process 800A executing at the subscriber device may involve generating and executing a recording request with respect to a program asset. Such a recording request may be transmitted to an NPVR element or may involve recording at a local device (block 802). In the NPVR scenario, a playback request may be generated and transmitted to the NPVR element to play the program asset, wherein the playback request may include identification and/or location of a target subscriber device on which the program is to be played or otherwise rendered (block 804). The program asset is then received in a suitable playlist (e.g., at a specified time as described above) via an appropriate delivery network (block 806) using guaranteed/managed delivery and/or adaptive streaming. In a further embodiment, a process 800B executing at the subscriber device relates to restoration of local content that may have been deleted or otherwise rendered unavailable for some reason or accidentally. A request to restore a previously recorded program asset is generated at the subscriber device and transmitted to an NPVR element provided in accordance with the teachings herein (block 852). After appropriate decision logic is executed at the NPVR element as set forth above, a playlist containing the program asset is received via a suitable delivery network for storing/restoring the content on the local device, which may be the same as the requesting device in one implementation (block 854). It should be apparent that in this scenario the playlist may be delivered via an unmanaged network since there no need for guaranteed bandwidth (as may be necessary for playback).

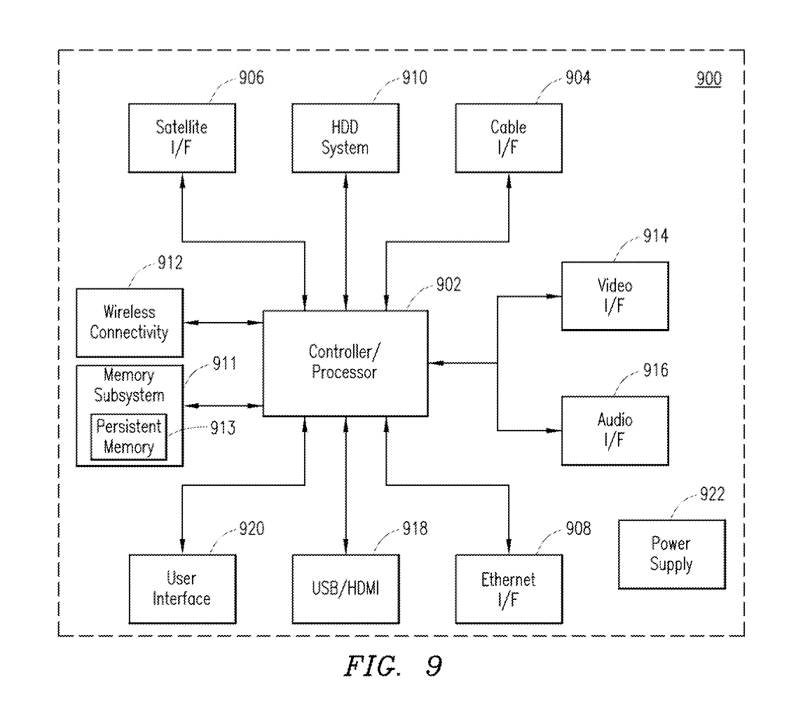

Referring to FIG. 9, depicted therein is a block diagram of an example subscriber device 900 adapted to operate with an NPVR system according to an embodiment of the present patent disclosure. Subscriber device 900 is generally representative of subscriber devices 106-1 to 106-M, subscriber device 402, and/or subscriber devices 602-1, 602-2 illustrated in FIGS. 1, 4 and 6, respectively, and may include appropriate hardware/software components and subsystems configured for performing any of the device-side processes (either individually or in any combination thereof) described hereinabove. One or more microcontrollers/processors 902 are provided for the overall control of the subscriber device 900 and for the execution of various stored program instructions embodied in a persistent memory 913 that may be part of a memory subsystem 911 of the subscriber device 900. Controller/processor complex referred to by reference numeral 902 may also be representative of other specialty processing modules such as graphic processors, video processors, digital signal processors (DSPs), and the like, operating in association with suitable video and audio interfaces 914, 916. Appropriate interfaces such as cable TV I/F modules 904 and satellite TV I/F modules 906 involving tuners, demodulators, descramblers, MPEG decoders/demuxes may be included for processing and interfacing with TV signals in a number of standards, e.g., DVB-S, DVB-C and DVB-T standards. As is known, the DVB-S standard and DVB-C standard signals may require Quadrature Amplitude Modulation (QAM) and Quadrature Phase Shift Keying (QPSK) techniques, whereas the DVB-T standard signals may require Orthogonal Frequency Division Multiplexing (OFDM) techniques. Other I/O or interfaces such as a graphic user interface 920, USB/HDMI ports 918, Ethernet I/F 908, and short-range and wide area wireless connectivity interfaces 912 are also provided. A hard disk drive (HDD) system 910 is provided for mass storage of all sorts of program assets such as A/V media, TV shows, movie titles, multimedia games, etc. Also included in the subscriber device 900 is a suitable power supply block 922, which may include AC/DC power conversion to provide power for the device 900. It should be appreciated that the actual power architecture for the subscriber device 900 may vary by the hardware platform used, e.g., depending upon the core SoC (System on Chip), memory, analog front-end, analog signal chain components and interfaces used in the specific platform, and the like. High efficiency single and multi-output switching regulators and low current LDO (low dropout) regulators may typically be required in addition to MOSFET load switches used for sequencing of the power rails in the subscriber device 900.

For purposes of the present patent application, the stored program instructions embodied in the persistent memory 913 (e.g., Flash memory) of the subscriber device 900 may include computer-readable instructions configured to perform the following acts or steps: facilitate generation and transmission of a request to the network node to restore a program asset that was locally stored on the subscriber device or to play back a program asset at a designated subscriber device; facilitate processing of the program asset received from the network node in a playlist via at least one of a managed delivery network and an unmanaged delivery network, wherein the program asset is built into the playlist by the network node based on at least one of: (i) a recording of the program asset in the NPVR system for a subscriber other than a subscriber associated with the subscriber device, (ii) a recording of the program asset in the NPVR system for the subscriber associated with the subscriber device; and (iii) if the program asset exists in a content system associated with the network node, retrieving the program asset's location information from the associated content system and selectively inserting any external media content at appropriate insertion points; and restore the program asset on the subscriber device or play the program asset on the designated subscriber device at the start time indicated in the request.

One skilled in the art will recognize that the order or sequence of the acts, steps, functions, components or blocks illustrated in any of the flowcharts depicted in FIGS. 3A-3B, FIG. 5, FIG. 7, or FIGS. 8A-8B may be modified, altered, replaced, customized or otherwise rearranged within a particular flowchart, including deletion or omission of a particular act, step, function, component or block. Moreover, the acts, steps, functions, components or blocks illustrated in a particular flowchart may be inter-mixed or otherwise inter-arranged or rearranged with the acts, steps, functions, components or blocks illustrated in another flowchart in order to effectuate additional variations, modifications and configurations with respect to one or more processes for purposes of practicing the teachings of the present patent disclosure. For example, the decision logic of blocks 503, 504, 506, 508 and 518 in FIG. 5 may be rearranged such that the decision logic of block 518 may be performed before the blocks 504, 506 or 508, and the decision logic of block 503 may be performed individually in conjunction with each of the decision blocks 504, 506 and 508 instead of being performed separately. Likewise, the decision logic of blocks 704 and 714 shown in FIG. 7 may be rearranged or interchanged, wherein a separate determination may be made first as to whether the program asset requested for playback was recorded/stored on the NPVR system for the first subscriber. Further, it should be apparent that the flowcharts of FIGS. 3A and 3B may be augmented or otherwise implemented with one or more additional acts, steps or blocks from the flowcharts of FIG. 5 or 7, respectively.

It should be appreciated that the embodiments of the present disclosure can advantageously reduce the amount of network-based storage required in conventional NPVR implementations where all requested programs are typically stored for each subscriber. Instead of storing the content on the NPVR system and retrieving it for different subscribers, the embodiments are adapted to verify if the content exists outside the NPVR system. If such content is permitted for access (under associated licenses, for example), the content may be transmitted to the subscribers (essentially, “redirecting” the content by the embodiments to the individual subscribers). Accordingly, in addition to storage-based costs, signaling traffic loads as well as bearer traffic loads over the managed networks may be better managed by the operators.

In the foregoing Detailed Description, functionalities of the various elements including components/blocks labeled or described as “module” or “process” or “processor” or “controller” or “computer” may be provided through the use of dedicated hardware as well as hardware capable of executing stored or preconfigured software. When provided by a processor, the functions may be provided by a single dedicated processor, by a single shared processor, or by a plurality of individual processors, some of which may be shared or distributed. Moreover, a “processor” or “controller” or “memory” may include, without limitation, digital signal processor (DSP) hardware, ASIC hardware, read only memory (ROM), random access memory (RAM), and/or other storage media.

Although various embodiments have been shown and described in detail, the claims are not limited to any particular embodiment or example. None of the above Detailed Description should be read as implying that any particular component, element, step, act, or function is essential such that it must be included in the scope of the claims. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed by the present claims. Accordingly, those skilled in the art will recognize that the exemplary embodiments described herein can be practiced with various modifications and alterations within the spirit and scope of the claims appended below.

1. A method performed in a network node operable in a network personal video recorder (NPVR) system, the method comprising:
receiving a request from a first subscriber for playing back a program asset;
upon determining that the program asset is not in an associated content system: further determining that the program asset is recorded within the NPVR system for a second subscriber;
building a playlist from the program asset recorded for the second subscriber, wherein the playlist includes a start time and an end time based on the second subscriber's recording of the program asset; and
transmitting the playlist including the program asset to the first subscriber.

2. The method as recited in claim 1, wherein the program asset comprises at least one of a pay television (TV) broadcast program, an over-the-air free TV broadcast program, a free-to-air satellite TV program, an Internet Protocol TV (IPTV) program, an on-demand program and a content asset supplied by a content provider.

3. The method as recited in claim 1, further comprising:
if the program asset is not recorded within the NPVR system for the second subscriber; then performing:
building a playlist from the program asset recorded for the first subscriber, wherein the playlist includes a start time and an end time based on the first subscriber's recording of the program asset; and
transmitting the playlist including the program asset to the first subscriber.

4. The method as recited in claim 1, wherein the associated content system comprises at least one of a time-shifted television (TSTV) system, a Video-On-Demand (VOD) system and an Over-the-Top (OTT) system.

5. The method as recited in claim 1, wherein the request from the first subscriber to play back the program asset includes at least one of an identification and a location of a subscriber device on which the playlist is to be played.

6. The method as recited in claim 5, wherein the playlist including the program asset and any inserted external media content is transmitted over one of a managed delivery network and an unmanaged delivery network to a particular subscriber device identified in the request.

7. The method as recited in claim 6, wherein the playlist including the program asset and any inserted external media content is transmitted using guaranteed bandwidth delivery via the managed delivery network that is implemented as a network overlaid on one of a coaxial TV cable network, a hybrid fiber coaxial (HFC) TV cable network, a digital subscriber line (DSL) network, a broadband satellite TV network and a broadband wireless telecommunications network.

8. The method as recited in claim 6, wherein the playlist including the program asset and any inserted external media content is transmitted using adaptive bitrate streaming.

9. A subscriber device configured to operate with a network node disposed in a network personal video recorder (NPVR) system, the subscriber device comprising:
one or more processors; and
a memory subsystem coupled to the one or more processors, the memory subsystem including a persistent memory,
wherein the persistent memory includes instructions configured to:
facilitate generation and transmission of a request to the network node to restore a program asset that was locally stored on the subscriber device;
facilitate processing of the program asset received from the network node in a playlist via at least one of a managed delivery network and an unmanaged delivery network, wherein the program asset is built into the playlist by the network node based on a recording of the program asset in the NPVR system for a subscriber other than a subscriber associated with the subscriber device, upon determining that the program asset is not in an associated content system; and
restore the program asset on the subscriber device.

10. The subscriber device as recited in claim 9, wherein the program asset comprises at least one of a pay television (TV) broadcast program, an over-the-air free TV broadcast program, a free-to-air satellite TV program, an Internet Protocol TV (IPTV) program, an on-demand program and a content asset supplied by a content provider.

11. The subscriber device as recited in claim 9, wherein the associated content system comprises at least one of a time-shifted television (TSTV) system, a Video-On-Demand (VOD) system and an Over-the-Top (OTT) system.

12. The subscriber device as recited in claim 9, further comprising an interface for connecting to at least one of the managed delivery network and the unmanaged delivery network.

13. The subscriber device as recited in claim 12, wherein the interface is adapted to receive the playlist including the program asset and any inserted external media content using adaptive bitrate streaming.

14. The subscriber device as recited in claim 12, wherein the interface is adapted to receive the playlist including the program asset and any inserted external media content using guaranteed bandwidth delivery via the managed delivery network that is implemented as a network overlaid on one of a coaxial TV cable network, a hybrid fiber coaxial (HFC) TV cable network, a digital subscriber line (DSL) network, a broadband satellite TV network and a broadband wireless telecommunications network.

15. The subscriber device as recited in claim 14, wherein the external media content comprises at least one of local media campaign content and national media campaign content included in a broadcast transmission of the program asset when the program asset was locally stored on the subscriber device.

16. A subscriber device configured to operate with a network node disposed in a network personal video recorder (NPVR) system, the subscriber device comprising:
one or more processors; and
a memory subsystem coupled to the one or more processors, the memory subsystem including a persistent memory,
wherein the persistent memory includes instructions configured to:
facilitate generation and transmission of a request to the network node to play back a program asset, the request including a start time for playing back the program asset;
facilitate processing of the program asset received from the network node in a playlist via at least one of a managed delivery network and an unmanaged delivery network, wherein the program asset is built into the playlist by the network node based on a recording of the program asset in the NPVR system for a subscriber other than a subscriber associated with the subscriber device, upon determining that the program asset is not in an associated content system; and
play the program asset on the subscriber device at the start time indicated in the request.

17. The subscriber device as recited in claim 16, wherein the program asset comprises at least one of a pay television (TV) broadcast program, an over-the-air free TV broadcast program, a free-to-air satellite TV program, an Internet Protocol TV (IPTV) program, an on-demand program and a content asset supplied by a content provider.

18. The subscriber device as recited in claim 16, wherein the associated content system comprises at least one of a time-shifted television (TSTV) system, a Video-On-Demand (VOD) system and an Over-the-Top (OTT) system.

19. The subscriber device as recited in claim 16, further comprising an interface for connecting to at least one of the managed delivery network and the unmanaged delivery network.

20. The subscriber device as recited in claim 19, wherein the interface is adapted to receive the playlist including the program asset and any inserted external media content using adaptive bitrate streaming.

21. The subscriber device as recited in claim 19, wherein the interface is adapted to receive the playlist including the program asset and any inserted external media content using guaranteed bandwidth delivery via the managed delivery network that is implemented as a network overlaid on one of a coaxial TV cable network, a hybrid fiber coaxial (HFC) TV cable network, a digital subscriber line (DSL) network, a broadband satellite TV network and a broadband wireless telecommunications network.

22. The subscriber device as recited in claim 21, wherein the external media content comprises at least one of local media campaign content and national media campaign content included in a broadcast transmission of the program asset.

23. A method performed in a subscriber device configured to operate with a network node disposed in a network personal video recorder (NPVR) system, the method comprising:
generating and transmitting a request to the network node to restore a program asset that was locally stored on the subscriber device;
receiving the program asset from the network node in a playlist via at least one of a managed delivery network and an unmanaged delivery network, wherein the program asset is built into the playlist by the network node based on a recording of the program asset in the NPVR system for a subscriber other than a subscriber associated with the subscriber device, upon determining that the program asset is not in an associated content system; and
restoring the program asset on the subscriber device.

24. The method as recited in claim 23, wherein the program asset comprises at least one of a pay television (TV) broadcast program, an over-the-air free TV broadcast program, a free-to-air satellite TV program, an Internet Protocol TV (IPTV) program, an on-demand program and a content asset supplied by a content provider.

25. The method as recited in claim 23, wherein the associated content system comprises at least one of a time-shifted television (TSTV) system, a Video-On-Demand (VOD) system and an Over-the-Top (OTT) system.

26. The method as recited in claim 23, wherein the playlist including the program asset and any inserted external media content is received using adaptive bitrate streaming.

27. The method as recited in claim 23, wherein the playlist including the program asset and any inserted external media content is received using guaranteed bandwidth delivery via the managed delivery network that is implemented as a network overlaid on one of a coaxial TV cable network, a hybrid fiber coaxial (HFC) TV cable network, a digital subscriber line (DSL) network, a broadband satellite TV network and a broadband wireless telecommunications network.

28. The method as recited in claim 27, wherein the external media content comprises at least one of local media campaign content and national media campaign content included in a broadcast transmission of the program asset when the program asset was locally stored on the subscriber device.
